(19) United States
(12) Patent Application Publication
(10) Pub. No.: US 2024/0064851 A1
(43) Pub. Date: Feb. 22, 2024

(54) MESSAGE TRANSMISSION VIA NON-TERRESTRIAL NETWORK

(71) Applicant: QUALCOMM Incorporated, San Diego, CA (US)

(72) Inventors: Qiaoyu LI, Beijing (CN); Yu ZHANG, San Diego, CA (US); Hao XU, Beijing (CN); Chao WEI, Beijing (CN); Jing DAI, Beijing (CN); Chenxi HAO, Beijing (CN); Wanshi CHEN, San Diego, CA (US)

(21) Appl. No.: 18/265,886

(22) PCT Filed: Feb. 26, 2021
(86) PCT No.: PCT/CN2021/078012

§ 371 Date: Jun. 7, 2023

(51) Int. Cl. H04W 76/27

(52) U.S. Cl. CPC H04W 76/27

(57) ABSTRACT

A UE in one of an RRC idle mode or an RRC inactive mode may generate an emergency message including one or more of GPS coordinates, a timestamp, a UE ID, a personal ID of a user of the UE, an emergency level, or an emergency type, and transmit the emergency message to an NR-NTN. The emergency message may be transmitted in a dedicated time or frequency resource. The base station may receive the emergency message from the UE and forward the UE information to a network.

### INTRODUCTION

The present disclosure relates generally to communication systems, and more particularly, to a method and apparatus for a user equipment (UE) to generate and transmitting message to network in at least one radio resource control (RRC) mode.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. A method of wireless communication at a user equipment (UE) may include generating a message including at least one of global positioning system (GPS) coordinates, a timestamp, a UE identifier (ID), a personal ID of a user of the UE, an emergency level, or an emergency type, and transmitting the message to a wireless network, the UE being in one of an RRC idle mode or an RRC inactive mode.

An apparatus for wireless communication at an UE may include means for generating a message including at least one of the GPS coordinates, the timestamp, the UE ID, the personal ID of the user of the UE, the emergency level, or the emergency type, and means for transmitting the message to the wireless network, the UE being in one of the RRC idle mode or the RRC inactive mode.

An apparatus for wireless communication at an UE may include a memory, and at least one processor coupled to the memory and configured to generate a message including at least one of the GPS coordinates, the timestamp, the UE ID, the personal ID of the user of the UE, the emergency level, or the emergency type, and transmit the message to the wireless network, the UE being in one of the RRC idle mode or the RRC inactive mode.

A computer-readable medium storing computer executable code for an UE, the code when executed by a processor cause the processor to generate a message including at least one of the GPS coordinates, the timestamp, the UE ID, the personal ID of the user of the UE, the emergency level, or the emergency type, and transmit the message to the wireless network, the UE being in one of the RRC idle mode or the RRC inactive mode.

A method of wireless communication at a wireless network may include receiving, from a UE in one of the RRC idle mode or the RRC inactive mode, a message including at least one of the GPS coordinates, the timestamp, the UE, a personal ID of the user of the UE, the emergency level, or the emergency type, and forwarding UE information to a network based on the received message.

An apparatus for wireless communication at a wireless network, may include means for receiving, from a UE in one of the RRC idle mode or the RRC inactive mode, a message including at least one of the GPS coordinates, the timestamp, the UE, a personal ID of the user of the UE, the emergency level, or the emergency type, and means for forwarding UE information to a network based on the received message.

An apparatus for wireless communication at a wireless network may include a memory, and at least one processor coupled to the memory and configured to receive, from a UE in one of the RRC idle mode or the RRC inactive mode, a message including at least one of the GPS coordinates, the timestamp, the UE, a personal ID of the user of the UE, the emergency level, or the emergency type, and forward UE information to a network based on the received message.

A computer-readable medium storing computer executable code of a wireless network, the code when executed by a processor cause the processor to receive, from a UE in one of the RRC idle mode or the RRC inactive mode, a message including at least one of the GPS coordinates, the timestamp, the UE, a personal ID of the user of the UE, the emergency level, or the emergency type, and forward UE information to a network based on the received message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A and 4B illustrate examples of NR-NTN configurations.

FIG. 5 is a communication diagram of wireless communication.

FIG. 6 is a flowchart of a method of wireless communication.

FIG. 7 is a flowchart of a method of wireless communication.

FIG. 8 is a diagram illustrating an example of a hardware implementation for an example apparatus.

FIG. 9 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In some aspects, such as in the case of the remote emergency environment, a UE may access a non-terrestrial wireless network to send or receive wireless communication. Satellite access may enable the UE to send messages, including an emergency message, in remote locations where the UE may not be able to access a terrestrial network. However, transmissions to an NTN may consume more power than transmissions to a terrestrial network and may involve larger amounts of propagation delay due to the distance between a UE and a satellite. In some examples, time and/or frequency synchronization, beam management (BM), and handover (HO) operations may involve added complexity. Aspects presented herein provide UE more power-efficient message transmission to improve the power consumption, the time/frequency synchronization, and/or the BM/HO operations of transmitting the emergency messages over the NTN that may have relatively larger signal propagation distance and delay. In some aspects, the UE that is not RRC connected to the network may generate and transmit a message to the network via an NTN base station. In some aspects, the message may be an emergency message.

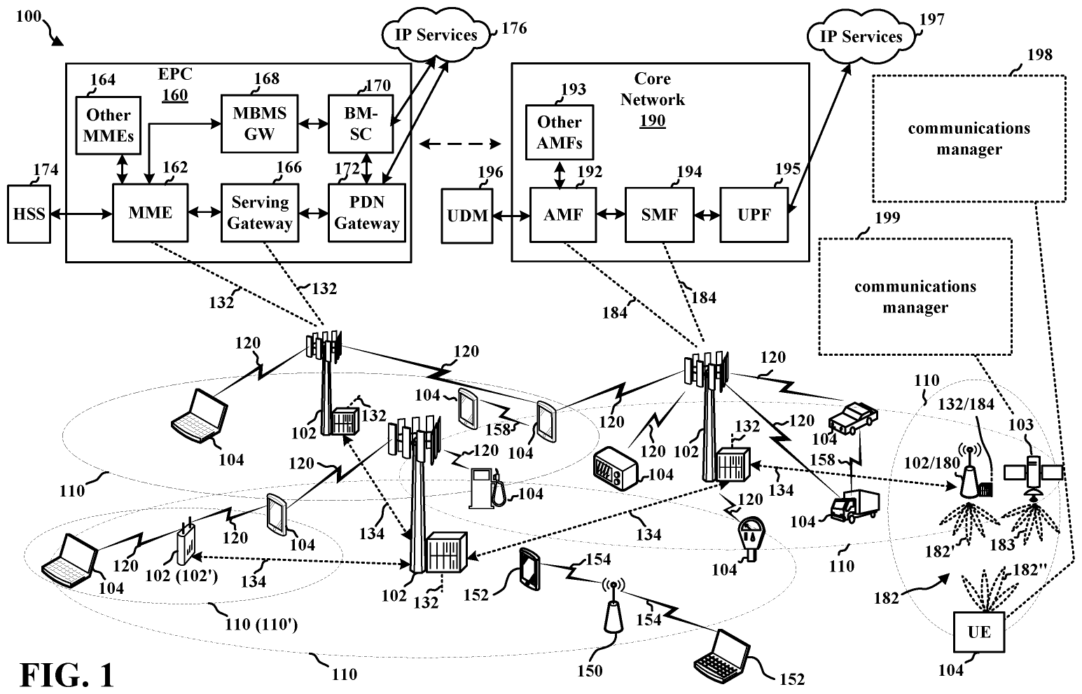

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

A base station 102, 103, or 180 may transmit a beamformed signal to the UE 104 in one or more transmit directions 182′. The UE 104 may receive the beamformed signal from the base station 102, 103, or 180 in one or more receive directions 182″. The UE 104 may also transmit a beamformed signal to the base station 102, 103, or 180 in one or more transmit directions. The base station 102, 103, or 180 may receive the beamformed signal from the UE 104 in one or more receive directions. The base station 102, 103, or 180/UE 104 may perform beam training to determine the best receive and transmit directions for each of the base station 102, 103, or 180/UE 104. The transmit and receive directions for the base station 102, 103, or 180 may or may not be the same. The transmit and receive directions for the UE 104 may or may not be the same.

The base station 103 may be a non-terrestrial network (NTN) base station 103. The NTN base station 103 may be associated with the core network 190 and/or EPC 160, in some aspects. The NTN may operate similar to a base station 102 or 180 with a non-terrestrial location, such as at a satellite. The NTN base station 103 may include a satellite or an unmanned aerial system (UAS) platform. The NTN base station 103 may transmit a beamformed signal to the UE 104 in one or more transmit directions 183, and the UE 104 may also transmit a beamformed signal to the NTN base station 103 in one or more transmit directions.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a communications manager 198 configured to generate a message including at least one of the GPS coordinates, the timestamp, the UE ID, the personal ID of the user of the UE, the emergency level, or the emergency type, and transmit the message to the wireless network, the UE being in one of the RRC idle mode or the RRC inactive mode. In certain aspects, a base station 102, 103, or 180 may include a communications manager 199 configured to receive, from a UE in one of the RRC idle mode or the RRC inactive mode, a message including at least one of the GPS coordinates, the timestamp, the UE, a personal ID of the user of the UE, the emergency level, or the emergency type, and forward UE information to a network based on the received message. Although the following description may be focused on 5G NR, the concepts described herein may be applicable to other similar areas, such as LTE, LTE-A, CDMA, GSM, and other wireless technologies.

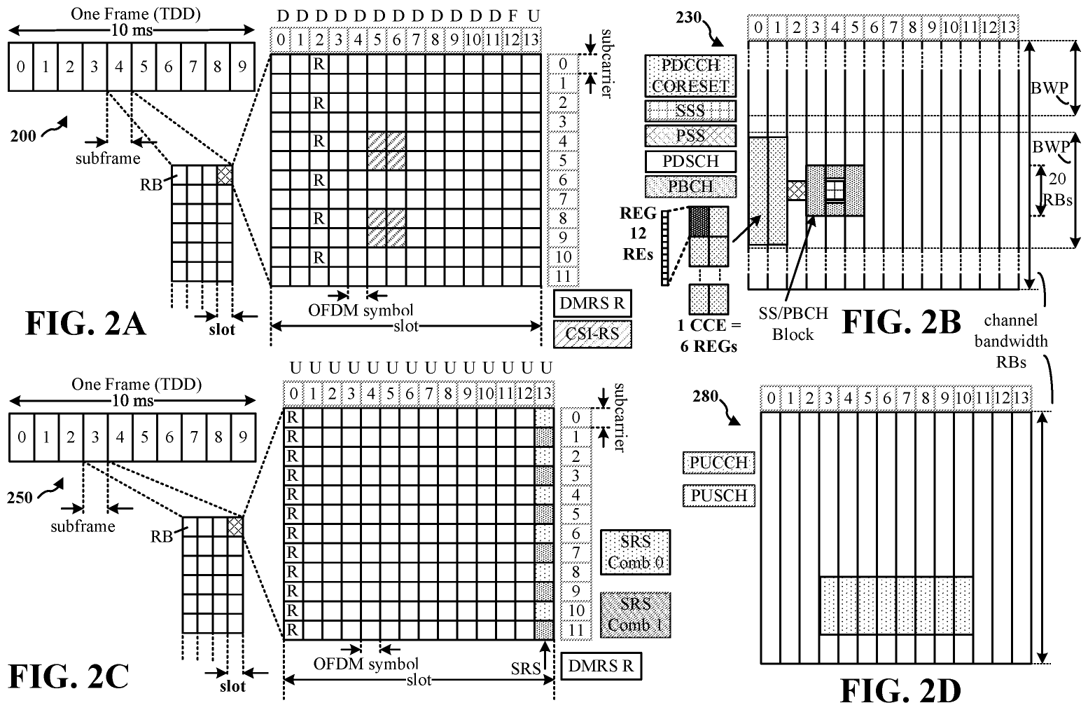

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

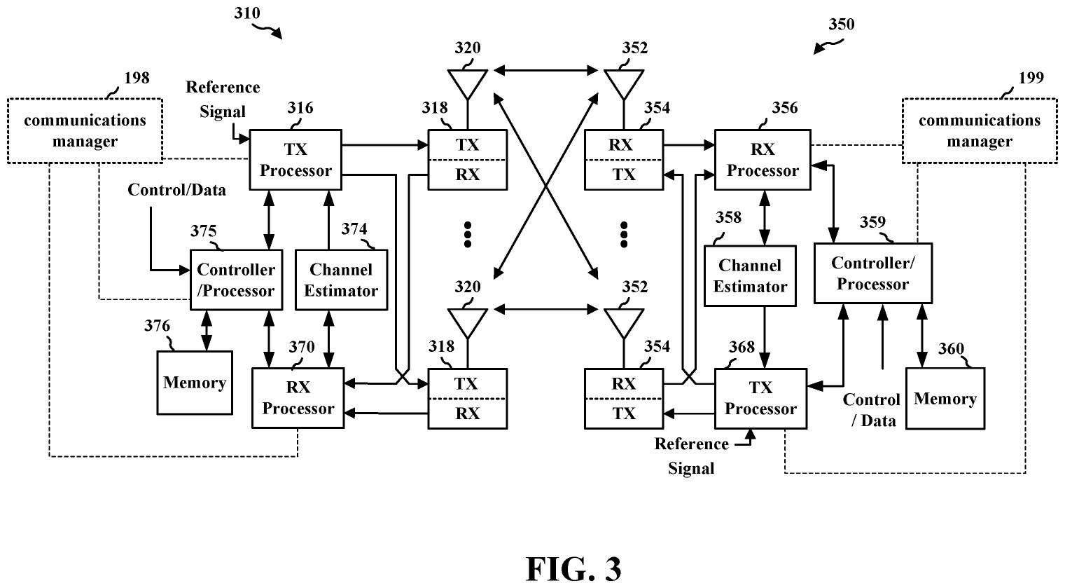

FIG. 3 is a block diagram of a base station 310 in communication with a UE 350 in an access network. The base station 310 may correspond to the base station 102/180 and/or the NTN base station 103. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the communications manager 198 of FIG. 1. At least one of the TX processor 316, the RX processor 370, and the controller/processor 375 may be configured to perform aspects in connection with the communications manager 199 of FIG. 1.

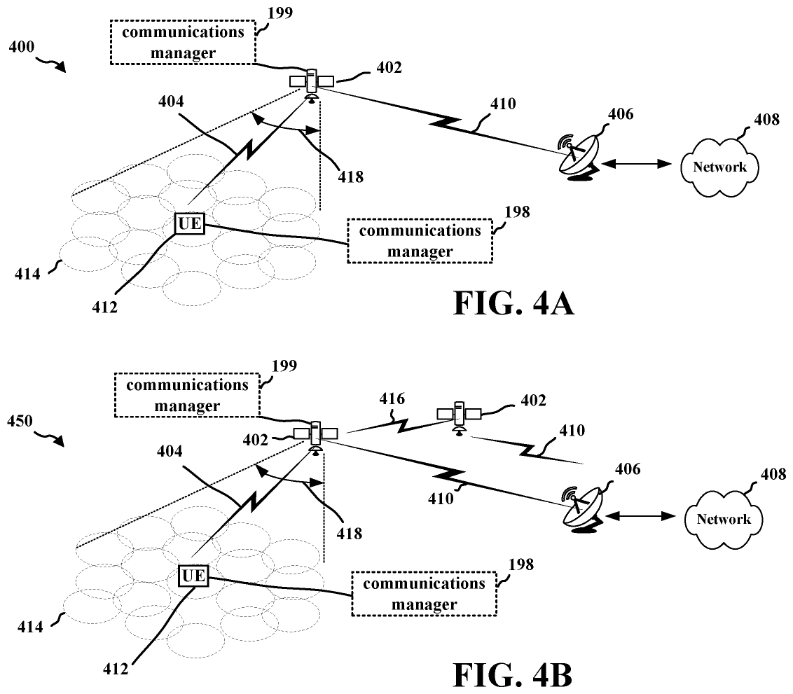

FIGS. 4A and 4B illustrate examples of NTN configurations. An NTN may refer to a network, or a segment of a network, that uses RF resources on board a satellite or UAS platform. In some aspects, the NTN may comprise an NR-NTN. FIG. 4A illustrates an NTN 400 that may include one or more satellite gateways 406 that connect the NTN to a public data network. For a transparent satellite, the gateway 406 may support functions to forward a signal from the satellite to a Uu interface, such as an NR-Uu interface. For a regenerative satellite, the gateway 406 may provide a transport network layer node, and may support transport protocols, e.g. acting as an IP router. The SRI provides IP trunk connections between the NTN GW and the Satellite to transport respectively NG or F1 interfaces. A GEO satellite (e.g., which may be referred to herein as an NTN base station 402) may be fed by one or more gateways 406 deployed across the satellite targeted coverage, which may correspond to regional coverage or even continental coverage. A non-GEO satellite may be served successively by one or more gateways 406 at a time, and the NTN may be configured to provide service and feeder link continuity between the successive serving gateways 406 with a time duration to perform mobility anchoring and handover. The NTN base station 402, including satellites or UAS platform 402, may communicate with the data network 408 through a feeder link 410 established between the NTN base station and a gateway 406 in order to provide service to one or more UEs 412 within the coverage, or field of view 418, of the NTN base station 402 via a service link 404. A satellite may correspond to a space-borne vehicle embarking a bent pipe payload or a regenerative payload telecommunication transmitter, placed into Low-Earth Orbit (LEO), Medium-Earth Orbit (MEO), or Geostationary Earth Orbit (GEO). A UAS may refer to a system encompassing Tethered UAS (TUA), Lighter Than Air UAS (LTA), Heavier Than Air UAS (HTA), e.g., in altitudes typically between 8 and 50 km including High Altitude Platforms (HAPs). A feeder link comprises a wireless link between an NTN gateway and a satellite, UAS, etc. A service link may refer to a radio link between a satellite and a UE. As described in connection with FIG. 1, the NTN base station 402 may use one or more directional beams, e.g., beamforming, to exchange communication with the UE 412. Therefore, the diagram of the NTN 400 illustrates that the field of view 418 of the NTN base station 402 may include areas covered by separate beams, e.g., beam foot print 414. A satellite beam may refer to a wireless communication beam generated by an antenna on-board a satellite.

FIG. 4B includes an NTN 450 illustrates that UEs 412 may communicate with an NTN base station 402, including satellites or UAS platform, via service link 404, and one or more NTN base stations 402 may relay the communication for another NTN base station 402 through inter-satellite link (ISL) 416, and the plurality of NTN base stations 402 may communicate with the data network 408 through the feeder link 410 established between the plurality of NTN base stations 402 and the gateway 406. ISL links may be provided between a constellation of satellites, and may involve the use of transparent payloads on board the satellites. The ISL may operate in an RF frequency or an optical band. The NTN base station 402 of FIGS. 4A and 4B may be configured to perform aspects in connection with the communications manager 199 of FIG. 1. The UE 412 of FIGS. 4A and 4B may be configured to perform aspects in connection with the communications manager 198 of FIG. 1.

In some aspects, the NTN may be based on transparent payload, e.g., a payload that changes the frequency carrier of the uplink RF signal, filters and amplifies it before transmitting it on the downlink. The NTN may be based on a regenerative payload, e.g., payload that transforms and amplifies an uplink RF signal before transmitting it on the downlink. The transformation of the signal refers to digital processing that may include demodulation, decoding, re-encoding, re-modulation and/or filtering.

The transmission of communication over a satellite radio interface (SRI) may involve much longer propagation delays compared to a terrestrial transport links. For example, a length for an Earth-satellite link can go from a few thousands of km (LEO scenario) to several tens of thousands of km (GEO scenario). Thus, the one way delay over the SRI may range from 6 ms (LEO at 600 km and 10° elevation) to approximately 136 ms (GEO at 35788 km and 10° elevation).

In one aspect, NTN UEs may have an enhanced timing relationship such that the data transmissions from multiple devices to the NTN base stations, including the satellite or UAS platform, may be synchronized. The synchronization of the signal between the NTN handheld devices and the NTN base stations, including the satellite or UAS platform, may be enhanced based on one or more of a GPS signal/coordinates, a global navigation satellite system (GNSS) signal, or a satellite orbit calendar (or satellite ephemeris information).

In another aspect, due to the relatively large distance between the NTN UE devices and the NTN base stations, the timing advance may be calculated with improved accuracy. Also, due to the distance of signal propagation, the data transmission between the NTN UE and the NTN base stations may have an increased number of HARQ processes to reduce throughput degradation.

In another aspect, the NTN wireless communication may have enhanced random access procedures to compensate for the regions with overlapping signal transmissions.

In some aspects, certain scenarios of NR-NTN may be associated with handheld transmitters having 23 dBm uplink transmission equivalent isotropic radiated power (EIRP) and signal-to-noise ratio (SNR) configuration comparable to NR terrestrial networks. Table 1 provides a list of example configurations of NR-NTNs that may be associated with NR terrestrial handheld transmitters/devices. That is, some aspects, including the example cases provided in Table 1, include devices, e.g., NR terrestrial devices, that may be connected with the NR-NTN.

TABLE 1
<NR-NTN configuration associated with NR terrestrial networks>

| | | | | Tx: | Rx: | | Path- | |
|---|---|---|---|---|---|---|---|---|
| | | | Freq | EIRP | G/T | BW | loss | CNR |
| Case | Orbit | Mode | [GHz] | [dBm] | [dB/T] | [MHz] | [dB] | [dB] |
| 1 | LEO- | DL | 2.0 | 78.8 | −31.6 | 30.0 | 159.1 | 6.6 |
| | 600 | UL | 2.0 | 23.0 | 1.1 | 0.4 | 159.1 | 2.8 |
| 2 | LEO- | DL | 2.0 | 84.8 | −31.6 | 30.0 | 164.5 | 7.2 |
| | 1200 | UL | 2.0 | 23.0 | 1.1 | 0.4 | 164.5 | −2.6 |
| 3 | LEO- | DL | 2.0 | 80.0 | −31.6 | 10.0 | 164.5 | 7.2 |
| | 1200 | UL | 2.0 | 23.0 | 1.1 | 0.4 | 164.5 | −2.6 |
| 4 | GEO | DL | 2.0 | 98.3 | −31.6 | 30.0 | 190.4 | −5.2 |
| | | UL | 2.0 | 23.0 | 14.0 | 0.4 | 190.4 | −15.7 |
| 5 | GEO | DL | 2.0 | 93.5 | −31.6 | 10.0 | 190.4 | −5.2 |
| | | UL | 2.0 | 23.0 | 14.0 | 0.4 | 190.4 | −15.7 |
| 6 | LEO- | DL | 2.0 | 72.8 | −31.6 | 30.0 | 159.1 | 0.6 |
| | 600 | UL | 2.0 | 23.0 | −4.9 | 0.4 | 159.1 | −3.2 |
| 7 | LEO- | DL | 2.0 | 68.0 | −31.6 | 10.0 | 159.1 | 0.6 |
| | 600 | UL | 2.0 | 23.0 | −4.9 | 0.4 | 159.1 | −3.2 |
| 8 | LEO- | DL | 2.0 | 78.8 | −31.6 | 30.0 | 164.5 | 1.2 |
| | 1200 | UL | 2.0 | 23.0 | −4.9 | 0.4 | 164.5 | −8.6 |
| 9 | LEO- | DL | 2.0 | 74.0 | −31.6 | 10.0 | 164.5 | 1.2 |
| | 1200 | UL | 2.0 | 23.0 | −4.9 | 0.4 | 164.5 | −8.6 |

In some aspects, a UE may access an NTN to send or receive wireless communication. In some aspects, the UE may access the NTN in remote environments, or in circumstances, in which the UE does not have a connection with a terrestrial network. Satellite access may enable the UE to send messages, including an emergency message, in remote locations where the UE may not be able to access a terrestrial network. However, transmissions to an NTN may consume more power than transmissions to a terrestrial network and may involve larger amounts of propagation delay due to the distance between a UE and a satellite. As well, time and/or frequency synchronization, BM, and HO operations may involve added complexity. Aspects presented herein provide for more power efficient message transmission to address the relatively high power consumption, challenging time/frequency synchronization, and complex BM/HO operations of the transmission of the messages due to the large signal propagation distance and delay. In some aspects, the UE in one of an RRC idle mode or an RRC inactive mode may generate and transmit a message to a NTN including at least one of GPS coordinates, a timestamp, or a UE ID, the personal ID of the user of the UE while remaining in the RRC idle mode or the RRC inactive mode. In some aspects, the message may be an emergency message, and the message may include at least one of an emergency level or an emergency type.

In one aspect of delay, the UE accessing the NTN may have a round-trip propagation delay of 12.89 ms with NTN base station at low earth orbit (LEO) of 600 miles or less (LEO-600), 20.89 ms with NTN base station at LEO of 1200 mile or less (LEO-1200), and 270.73 ms with NTN base station at geosynchronous equatorial orbit (GEO).

In one aspect of synchronization, the UE may apply pre-compensation on the time/frequency based on orbit-calendar and GPS-info to achieve better UL synchronization at the NTN base station.

In one aspect of BM/HO, the NTN base station may use multiple beams with complex BM/RACH procedures to compensate for a relatively short visible duration, e.g., a few minutes, of the NTN base station, e.g., LEO satellite, for typical handheld devices for better performance.

The ability to access the NTN such aspects may enable the UE to transmit wireless messages in circumstances such as an air-crash, shipwreck, remote traffic accident, hiking accident, and avalanche, among other examples. In one aspect, the device user may not be conscious or may not be able to perform human-to-human communications, e.g., making phone calls or sending custom messages. In some aspects, the UE may not be accessible by a user. In another aspect, the device owner may have a limited ability to operate the device with simple buttons. In another aspect, the UE may be configured to detect an occurrence of an incident or event that automatically triggers an emergency rescue message transmission from the UE. In some aspects, an artificial intelligence (AI), neural network (NN), or machine learning (ML) component may be configured to detect the occurrence of the event and to trigger the message. For example, a UE may be configured to detect emergency environments and to autonomously trigger an emergency rescue message transmission based on the detected emergency environment. In some aspects, a UE may access the NTN to transmit data transmissions, e.g., emergency messages, via the NTN while meeting the configurations for accessing the NTN.

Although aspects are described herein for emergency messages, the aspects may also be applicable to other types of messages. As well, although aspects are described herein for message transmission to an NTN, the aspects may be similarly applied for message transmission, such as emergency message transmission, to other types of networks.

Aspects presented herein enable the UE to transmit a message while in the RRC_IDLE mode or the RRC_INACTIVE mode, with improved power efficiency. The message may include an emergency rescue message in some aspects. The UEs in the RRC_IDLE mode or the RRC_INACTIVE mode may not have an RRC connection with at least one of the NR terrestrial network or the NTN, and the UEs in the RRC_IDLE mode or the RRC_INACTIVE mode may be configured with procedures to transmit one or more message without completely establishing the RRC connection with at least one of the NR terrestrial network or the NTN. In some aspects, the UEs in the remote emergency environment and/or the user may have potential difficulties with human-to-human communications, or user initiated communication, and therefore, a low power machine-type message transmission via NTN (e.g., NR-NTN) may be implemented. In one aspect, the device user may be able to operate the device with simple buttons to transmit the emergency message. In another aspect, the device may be able to detect the incidents and automatically trigger emergency rescue message transmission, e.g., such as an AI component, NN component, or ML component.

In some aspects, an NTN dedicated resource may be provided for transmission of the emergency message by the UE. That is, the UE in the RRC_IDLE mode or the RRC_INACTIVE mode may transmit the emergency message to the NTN using a set of dedicated resources.

In some aspects, the dedicated resource for transmitting such NTN messages may be defined, preconfigured, or specified. That is, the dedicated resource for the UE to transmit the emergency message to the NTN may be defined and known by the UE and the NTN, and the UE may transmit the emergency message on the defined dedicated resources with reduced signaling overhead. In one aspect, the configuration of one or more resources may be fixed globally. In another aspect, the configuration of the one or more resources may be dependent on one or more of a GPS signal/coordinates, a global navigation satellite system (GNSS) signal, or a satellite orbit calendar (or satellite ephemeris information). Thus, the UE may determine its current location and may use the location of the UE to determine a corresponding set of resources for transmission of the message to the NTN. The UE may compare the current location to a satellite orbit calendar in order to determine resources for use with an NT. Satellite ephemeris information may be used to predict feeder link switchover occurrences, mobility management events (idle and connected mode), radio resource management, as well as pre/post compensation of common delay/Doppler shift/variation in an NTN based NG-RAN, for example.

The resources may include time and/or frequency resources. For example, a time resource may enable the UE to transmit the message during a time at which the NTN base station monitors for such messages.

In another aspect, the UE may transmit a sequence without time-domain (TD) synchronization between the UE and the NTN base station, and may instead be transmitted in a certain frequency-domain (FD) resource that are configured or defined for the message from the UE to the NTN base station, e.g., with a relatively low FD offset configuration. That is, the UE may transmit the message as a sequence on the one or more dedicated frequency resources, without performing any TD synchronization, to the NTN base station. In one aspect, the NTN base station, including the satellites, may be configured to perform the signal synchronization and detection. That is, the NTN base station may be configured to detect or monitor for the transmission of the message from the UE and perform the signal synchronization. In some aspects, the message may be an emergency message or for a message to an NTN by a UE without a connection, among other examples.

In some aspects, the one or more dedicated resources for transmitting the message may be configured in system information by a network. For example, the UE may receive a configuration of the resources (e.g., time and/or frequency resources) for transmitting the message to the NTN in a MIB or remaining minimum system information (RMSI). The MIB or RMSI may indicate whether the synchronization raster includes the system information configuring the one or more dedicated resources for transmitting the message, or the MIB/RMSI may directly indicate the one or more dedicated resources. In some aspects, the system information may indicate a dependency on/correspondence to geographic location for the resources or TD synchronization requirements for the NTN. For example, the UE may receive the system information from the NTN. In some aspects, the message may be an emergency message or for a message to an NTN by a UE without a connection, among other examples.

In some aspects, the one or more dedicated resources for transmitting the message may be scheduled during a random access channel (RACH) procedure, e.g., by random access response (RAR) UL-grant for message (Msg3). UE may use a random access procedure in order to communicate with a base station. For example, the UE may use the random access procedure to request an RRC connection, to re-establish an RRC connection, resume an RRC connection, etc. A UE may use a random access procedure in order to communicate with an NTN base station. For example, the UE may use the random access procedure to request an RRC connection, to re-establish an RRC connection, resume an RRC connection, etc. The UE may initiate the random access message exchange by transmitting first random access message (e.g., Msg 1) including a preamble. Prior to sending the Msg 1, the UE may obtain random access parameters, e.g., including preamble format parameters, time and frequency resources, parameters for determining root sequences and/or cyclic shifts for a random access preamble, etc., e.g., in system information from the base station, e.g., the NTN base station 402. The base station responds to the Msg 1 by sending a random access response message (e.g., Msg 2) and including a random access response (RAR). Upon receiving the Msg 2, the UE may transmit a third random access message (e.g., Msg 3) that includes an RRC connection request, an RRC connection re-establishment request, an RRC resume request, etc., depending on the trigger for the random access procedure. The base station may then complete the random access procedure by sending a fourth random access message (e.g., Msg 4) that may include scheduling information for an uplink transmission from the UE.

The UE may receive an indication of the message resources for transmitting a particular type of message in a random access message from the NTN base station (e.g., in Msg 2 or Msg 4). In one aspect, the associated one or more RACH occasions (ROs)/preambles may be dedicated for the particular type of message transmission, and the one or more ROs/preambles dedicated for the message transmission may be configured via system information. That is, the UE may receive system information configuring the one or more ROs/preambles dedicated for transmission of the particular type of message, and the UE may select to transmit the message to the NTN using the dedicated one or more ROs/preambles. For example, if the UE transmits the Msg 1 in the defined/configured RO or using a defined/configured preamble, the base station may determine that the message is a particular type of message from the UE. For example, the message may be an emergency message, and the UE may indicate an emergency status through the RO or preamble used in a Msg 1 random access transmission to the NTN base station.

In some aspects, the UE may transmit the NTN message on one or more resources that are dedicated for, or configured for, the particular type of message (e.g., an NTN emergency message). The dedicated/configured resources may including at least one of configured FD and/or TD resources, RACH occasions, preamble sequences, message A (MsgA) PUSCH occasions associated with the preconfigured RACH occasions, or Msg3 scheduled by a RAR UL-grant.

In some aspects, the system information configuring the dedicated resources for transmitting a particular type of message to the NTN may be assumed to be unchanged or consistent over time. In one aspect, the system information configuring the dedicated resources for the particular type of NR-NTN message can be assumed to be consistent. In another aspect, the system information configuring the dedicated resources for the particular type of NR-NTN message can be assumed to be consistent for a period of time, and the system information may be configured to indicate the remaining time duration that the system information is maintained consistently. That is, the UE may not need to periodically monitor for system information change, e.g., every 100 or 200 ms, based on the permanent, consistent system information or the remaining time duration that the system information is maintained consistently. Accordingly, the UE may reduce the UE power consumption to monitoring for the system information changes.

In some aspects, the resource dedicated for the certain NR-NTN message may be configured within frequencies dedicated for the NTN. In some aspects, the message may be an emergency message or for a message to an NTN by a UE without a connection, among other examples. In one aspect, the UE may not be expected to transmit the NTN dedicated messages using the resources configured within the frequencies dedicated for the NTN when the UE may access the terrestrial networks. That is, the UE may first determine whether the UE may access the NR terrestrial networks, and if the UE determines that the UE may access the NR terrestrial networks, the UE may not transmit the NTN dedicated message using the resources configured within the frequencies dedicated for the NTN. When the UE can set up an RRC connection with an terrestrial base station, such as an NR terrestrial base station, the UE may perform a random access procedure with the NR terrestrial network to send the messages to the network. If the UE determines that the UE may not access a terrestrial network, the UE may transmit the NTN dedicated messages using the resources configured in the frequencies dedicated for the NR-NTN. This implementation may be configured based on the UE having the ability to distinguish between an NTN base station and a terrestrial base station. For example, the UE may distinguish between the NR-NTN base station and the NR-terrestrial base station based on one or more of frequency-separation or different system information. Accordingly, malicious use of the resources may be prevented or reduced, and transmission congestion in the emergency resource may be reduced. In some aspect, the message may be an emergency message.

In some aspects, the resources for transmitting particular type of messages may be configured by system information. In one aspect, a sync-raster to search for such system information may be configured or preconfigured. In another aspect, the next sync-raster's location to search for such system information may be indicated in a sync-raster that does not include such system information. Accordingly, the UE may reduce the power consumption for searching such system information. In some aspect, the message may be an emergency message.

In some aspects, the UE may perform a listen-before-talk to confirm that the dedicated resource is available for transmitting particular type of messages. For example, in an air-crash, multiple devices may try to send out the signal simultaneously, which may cause transmission collision, e.g., with other UEs attempting to send a similar message. Accordingly, the LBT may prevent or reduce collisions of the transmission and may help to improve reception of the signal by an NTN base station. In some aspect, the message may be an emergency message.

In some aspects, the UE may coordinate the transmission of particular type of messages with a group of UEs. The coordination may be based on sidelink communication. As the UEs may be in a remote environment in which a terrestrial network is not accessible, the sidelink coordination may enable the UEs to more effectively transmit messages to the NTN. That is, the group of UEs may rely on sidelink coordination to transmit the message cooperatively. The UEs may exchange one or more sidelink transmissions between UEs in order to propose, accept, or otherwise negotiate aspects of coordinated transmission to the NTN. In one aspect, the group of UEs may be configured to perform a round robin transmission. That is, the group of UEs may coordinate the transmissions of the messages and take turns sequentially transmitting the messages to the NTN. The sequential transmission may reduce transmission collision between the group of UEs and may conserve battery use at each of the UEs so that the group of UEs may transmit repetitions of the message over a longer period of time. The sequential transmission of the messages may be repeated, e.g., based on a transmission pattern coordinated by the UEs. An example pattern may include a transmission by a first UE, followed by a transmission by a second UE, which is followed by a transmission from a third UE. Then, the pattern may repeat with a transmission by the first UE, followed by a transmission by the second UE, which is followed by a transmission from the third UE, and so forth. In another aspect, the group of UEs may be configured to transmit simultaneously. That is, the group of UEs may coordinate the transmissions of the messages to simultaneously transmit the same message to the NTN. The simultaneous transmission of the same message may increase the overall transmission power of the message and may improve the likelihood of reception by the NTN base station, e.g., increasing the SINR of the combined transmission. The TD synchronization among the group of UEs may be configured relatively stricter than the round robin transmission. In some aspect, the message may be an emergency message.

In some aspects, the message may be an emergency message, and the payload of the NTN dedicated emergency message may include at least one of GPS coordinates, a timestamp, a UE identifier (ID), a personal identifier of the owner of the UE, a level of the emergency, or a type of the emergency. Thus, the UE may transmit a message to a network comprising GPS coordinates, timestamp, UE ID, other personal identifier information, an emergency level, or a type of emergency without completing an RRC connection step. In the UE transmits the message to an NTN, the UE may transmit the message prior to establishing an RRC connection with the NTN. The UE may be in an RRC idle or RRC inactive state when the UE sends the message to the wireless network, for example.

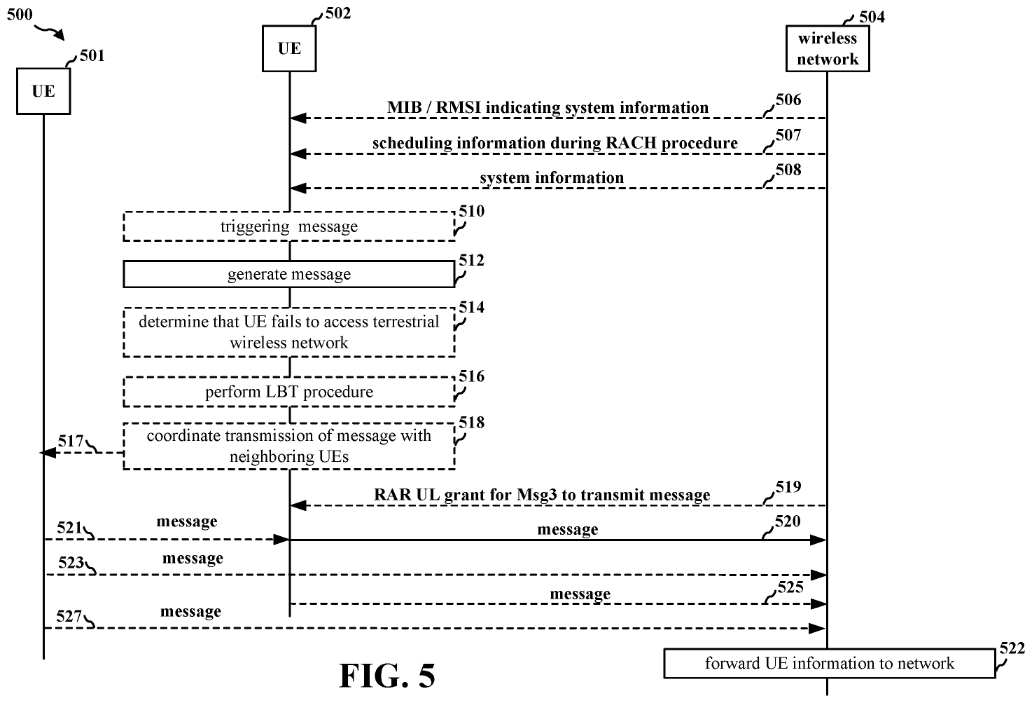

FIG. 5 is a communication diagram 500 of wireless communication. The communication diagram 500 may include a UE 502 and a wireless network 504. The UE 502 may be in one of an RRC idle mode or an RRC inactive mode. In some aspects, the wireless network 504 may include an NTN including an NTN base station. Aspects may be similarly applied to a terrestrial network.

At 506, the UE may receive a MIB or an RMSI indicating that a synchronization raster includes system information or the time or frequency resources for transmitting a message to the wireless network. The resources may be configured for a particular type of message, such as an emergency message or for a message to an NTN by a UE without a connection, among other examples.

At 507, the UE may receive scheduling information for transmitting the message during a RACH procedure associated with the type of message. The type may be an emergency message or an emergency message with an NTN. The UE may transmit the message using the scheduling information, e.g., at 520.

At 508, the UE may receive system information from the wireless network that indicates time or frequency resources for transmitting the message. That is, the UE may transmit the message at 520 using the time or frequency resource indicated in the system information. In one aspect, the time or frequency resources indicated in the system information may be consistent over time. In another aspect, the system information may indicate a duration of time associated with the time or frequency resources. The system information may include a first synchronization raster indicating time frequency resources for transmitting the message, and a second synchronization raster indicating one or more frequency and/or time domain locations for the first synchronization raster. The resources may be configured for a particular type of message, such as an emergency message or for a message to an NTN by a UE without a connection, among other examples.

In some aspects, one or more ROs or one or more preamble sequences associated with the RACH procedures may be dedicated for a type of the message as scheduled at 507, and the system information received at 508 may indicate the associated one or more ROs or one or more preambles that are configured for the type of the emergency message. For example, a set of one or more ROs or one or more preambles may be provided for emergency message, such as emergency messages with an NTN for a UE without an RRC connection.

At 510, the UE may trigger the message in response to an occurrence of an emergency event. For example, the UE may comprise an AI, NN, or ML component that is configured to detect the incidents and to automatically trigger emergency rescue message transmission to the wireless network 504, e.g., such as an NTN.

At 512, the UE generates a message including at least one of GPS coordinates, a timestamp, a UE ID, a personal ID of a user of the UE, an emergency level, or an emergency type. In some aspects, the message may comprise an emergency message that is triggered by the detection of an accident, an emergency condition, and/or a remote location without access to a terrestrial network.

For example, at 514, the UE may determine that the UE fails to, or is unable to, access a first type of wireless network to establish an RRC connection. For example, the UE may not detect a terrestrial network or may be unsuccessful in one or more attempts to establish a connection with the terrestrial network. Based on the determination that the UE fails to access the first type of wireless network to establish an RRC, the UE may transmit the message to the wireless network at 520 based on the determination that the UE fails to access the first type of wireless network to establish the RRC connection. The first type of wireless network may include a terrestrial wireless network and the wireless network to which the UE transmits the message 520 may be a non-terrestrial network NTN.

At 516, the UE may perform an LBT procedure before transmitting the message to the wireless network. The UE may transmit the message to the wireless network based on resources allocated for transmission of a type of the message being available for transmission. The LBT procedure may enable the UE to avoid transmission collisions with emergency messages from other UEs, in some aspects. The UE may refrain from transmitting, and may conserve battery power, if the LBT procedure is unsuccessful and may transmit the message 520 if the LBT procedure is successful.

At 518, the UE may coordinate the transmission of the message with one or more neighboring UEs. The UE may exchange sidelink communication 517 with the one or more neighboring UEs 501. In one aspect, the UE and the one or more UEs sequentially repeats the transmission of the message, e.g., as illustrated at 520, 523, 525, and 527. In some aspects the pattern may repeat until a response is received from the NTN. In some aspects, the pattern may repeat until one of the UEs is unable to transmit, e.g., due to low power or another reason. In another aspect, the UE and the one or more UEs transmit the message simultaneously to the wireless network, as shown at 520 and 521.

At 519, the UE may receiving a RAR UL grant including the scheduling information for a Msg3, when the message is transmitted in the Msg3.

At 520, the UE may transmit the message to the wireless network. The message may be transmitted to the wireless network on a dedicated time or frequency resource that is dedicated for a type of the message. In one aspect, the dedicated time or frequency resource may be based on a global allocation. In another aspect, the dedicated time or frequency resource may be based on at least one of the GPS coordinates or satellite ephemeris information. In another aspect, the message may be transmitted in the frequency resource for the messages without time domain synchronization with the wireless network. The message may include an NTN message (e.g., an NR-NTN message), and the message may be transmitted in a time frequency resource dedicated for a type of the NTN message. The type of the NTN message may include an emergency NTN message. The emergency message may be triggered by a user or may be triggered by detection of an emergency condition.

In some aspect, the UE may transmit the message to the wireless network during the RACH procedure associated with the type of message scheduled at 507 and one or more ROs or one or more preamble sequences associated with the RACH procedures dedicated for a type of the message as indicated by the system information received at 508. In one aspect, the UE may transmit the message in the Msg3 or the MsgA in a PUSCH occasion for the RACH procedure associated with the type of the message.

At 522, the wireless device may forward the UE information based on the message received from the UE at 520.

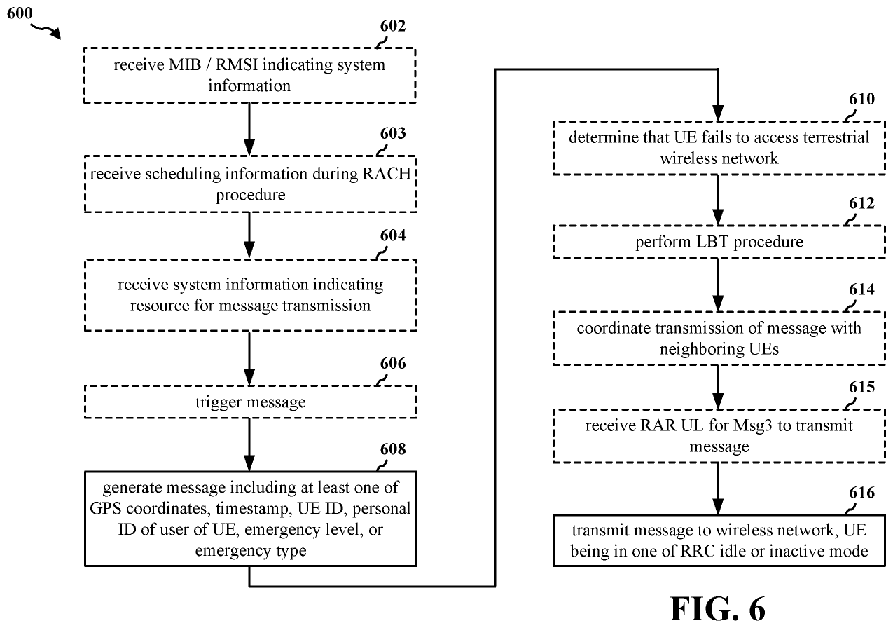

FIG. 6 is a flowchart 600 of a method of wireless communication. The method may be performed by a UE (e.g., the UE 104; the apparatus 802). At 602, the UE may be configured to receive a MIB or an RMSI indicating that a synchronization raster includes system information or the time or frequency resources for transmitting a message to the wireless network. The resources may be configured for a particular type of message, such as an emergency message or for a message to an NTN by a UE without a connection, among other examples. For example, 602 may be performed by a system information component 840.

At 603, the UE may be configured to receive scheduling information for transmitting the message during a RACH procedure associated with the type of message. The type may be an emergency message or an emergency message with an NTN. The UE may transmit the message using the scheduling information. In some aspect, one or more ROs or one or more preamble sequences associated with the RACH procedures may be dedicated for a type of the message as scheduled, and the system information received at 604 may indicate the associated one or more ROs or one or more preambles that are configured for the type of the emergency message. For example, a set of one or more ROs or one or more preambles may be provided for emergency message, such as emergency messages with an NTN for a UE without an RRC connection. For example, 603 may be performed by a RACH component 842.

At 604, the UE may be configured to receive system information from the wireless network that indicates time or frequency resources for transmitting the message. That is, the UE may transmit the message, e.g., at 616, using the time or frequency resource indicated in the system information. In one aspect, the time or frequency resources indicated in the system information may be consistent over time. In another aspect, the system information may indicate a duration of time associated with the time or frequency resources. The system information may include a first synchronization raster indicating time frequency resources for transmitting the message, and a second synchronization raster indicating one or more frequency and/or time domain locations for the first synchronization raster. The resources may be configured for a particular type of message, such as an emergency message or for a message to an NTN by a UE without a connection, among other examples. For example, 604 may be performed by the system information component 840.

At 606, the UE may be configured to trigger the message in response to an occurrence of an emergency event. For example, the UE may include an AI, NN, or ML component that is configured to detect the incidents and to automatically trigger emergency rescue message transmission to the wireless network, e.g., such as an NTN. For example, 606 may be performed by a communications manage component 844.

At 608, the UE may be configured to generates a message including at least one of GPS coordinates, a timestamp, a UE ID, a personal ID of a user of the UE, an emergency level, or an emergency type. In some aspects, the message may comprise an emergency message that is triggered by the detection of an accident, an emergency condition, and/or a remote location without access to a terrestrial network. The message may include one or more of GPS coordinates, a timestamp, a UE ID, a personal ID of a user of the UE, an emergency level, or an emergency type. For example, 608 may be performed by the communications manage component 844.

At 610, the UE may be configured to determine that the UE fails to, or is unable to, access a first type of wireless network to establish an RRC connection. For example, the UE may not detect a terrestrial network or may be unsuccessful in one or more attempts to establish a connection with the terrestrial network. Based on the determination that the UE fails to access the first type of wireless network to establish an RRC, the UE may transmit the message to the wireless network at 616 based on the determination that the UE fails to access the first type of wireless network to establish the RRC connection. The first type of wireless network may include a terrestrial wireless network and the wireless network to which the UE transmits the message may be a non-terrestrial network NTN. For example, 610 may be performed by the RACH component 842.

At 612, the UE may be configured to perform an LBT procedure before transmitting the message to the wireless network. The UE may transmit the message to the wireless network based on resources allocated for transmission of a type of the message being available for transmission. The LBT procedure may enable the UE to avoid transmission collisions with emergency messages from other UEs, in some aspects. The UE may refrain from transmitting, and may conserve battery power, if the LBT procedure is unsuccessful and may transmit the message if the LBT procedure is successful. For example, 612 may be performed by a LBT component 846.

At 614, the UE may be configured to coordinate the transmission of the message with one or more neighboring UEs. The UE may exchange sidelink communication with the one or more neighboring UEs. In one aspect, the UE and the one or more UEs sequentially repeats the transmission of the message. In some aspects the pattern may repeat until a response is received from the NTN. In some aspects, the pattern may repeat until one of the UEs is unable to transmit, e.g., due to low power or another reason. In another aspect, the UE and the one or more UEs transmit the message simultaneously to the wireless network. For example, 614 may be performed by a sidelink component 848.

At 615, the UE may be configured to receive a RAR UL grant including the scheduling information for a Msg3, when the message is transmitted in the Msg3. For example, 615 may be performed by the RACH component 842.

At 616, the UE may be configured to transmit the message to the wireless network. The message may be transmitted to the wireless network on a dedicated time or frequency resource that is dedicated for a type of the message. In one aspect, the dedicated time or frequency resource may be based on a global allocation. In another aspect, the dedicated time or frequency resource may be based on at least one of the GPS coordinates or satellite ephemeris information. In another aspect, the message may be transmitted in the frequency resource for the messages without time domain synchronization with the wireless network. The message may include an NTN message (e.g., an NR-NTN message), and the message may be transmitted in a time frequency resource dedicated for a type of the NTN message. The type of the NTN message may include an emergency NTN message. The emergency message may be triggered by a user or may be triggered by detection of an emergency condition. In some aspect, the UE may transmit the message to the wireless network during the RACH procedure associated with the type of message scheduled, e.g., at 603, and one or more ROs or one or more preamble sequences associated with the RACH procedures dedicated for a type of the message as indicated by the system information received at 604. In one aspect, the UE may transmit the message in the Msg3 or the MsgA in a PUSCH occasion for the RACH procedure associated with the type of the message. For example, 616 may be performed by a transmission component 834.

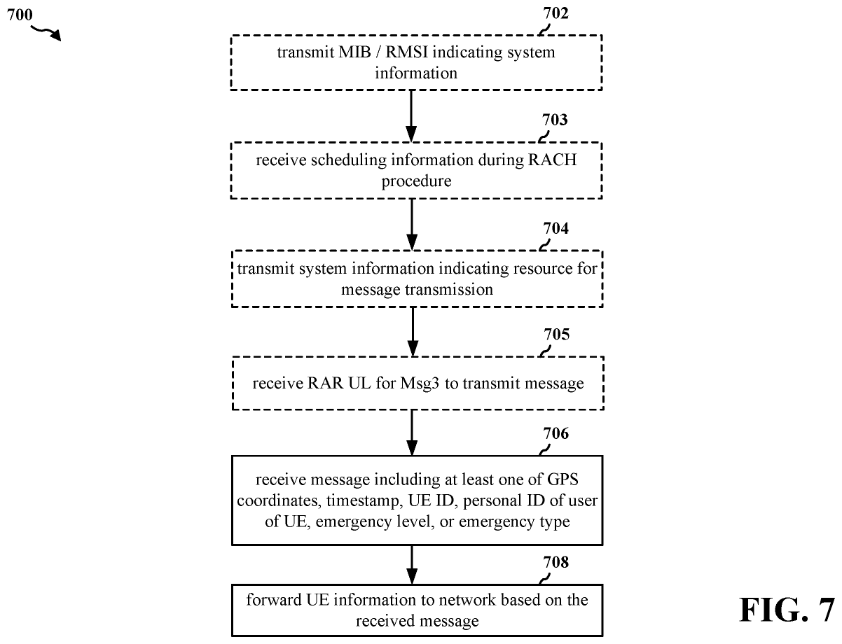

FIG. 7 is a flowchart 700 of a method of wireless communication. The method may be performed by a wireless network (e.g., the base station 102/180; the apparatus 702). At 702, the wireless network may be configured to transmit a MIB or an RMSI indicating that a synchronization raster includes system information or the time or frequency resources for receiving a message from the wireless network. The resources may be configured for a particular type of message, such as an emergency message or for a message from a UE without a connection, among other examples. For example, 702 may be performed by a system information component 940.

At 703, the wireless network may be configured to transmit scheduling information for transmitting the message during a RACH procedure associated with the type of message. The type may be an emergency message or an emergency message with an NTN. The base station may receive the message using the scheduling information at 706. In some aspect, one or more ROs or one or more preamble sequences associated with the RACH procedures may be dedicated for a type of the message as scheduled, and the system information received at 704 may indicate the associated one or more ROs or one or more preambles that are configured for the type of the emergency message. For example, a set of one or more ROs or one or more preambles may be provided for an emergency message, such as emergency messages with an NTN for a UE without an RRC connection. For example, 703 may be performed by a RACH component 942.

At 704, the wireless network may be configured to transmit system information to the UE that indicates the time or frequency resources for the UE to transmit the message. That is, the wireless network may receive the message, e.g., at 706, using the time or frequency resource indicated in the system information. In one aspect, the time or frequency resources indicated in the system information may be consistent over time. In another aspect, the system information may indicate a duration of time associated with the time or frequency resources. The system information may include a first synchronization raster indicating time frequency resources for transmitting the message and a second synchronization raster indicating one or more frequency and/or time domain locations for the first synchronization raster. The resources may be configured for a particular type of message, such as an emergency message or for a message to an NTN by a UE without a connection, among other examples. For example, 704 may be performed by the system information component 940.

At 705, the wireless network may be configured to transmit a RAR UL grant, including the scheduling information for a Msg3, when the message is transmitted in the Msg3. For example, 705 may be performed by the RACH component 942.

At 706, the wireless network may be configured to receive the message from the UE. The message may be received from the UE on a dedicated time or frequency resource that is dedicated for a type of the message. In one aspect, the dedicated time or frequency resource may be based on a global allocation. In another aspect, the dedicated time or frequency resource may be based on at least one of the GPS coordinates or satellite ephemeris information. In another aspect, the message may be received in the frequency resource for the messages without time-domain synchronization with the UE. The message may include an NTN message (e.g., an NR-NTN message), and the message may be transmitted in a time frequency resource dedicated for a type of the NTN message. The type of the NTN message may include an emergency NTN message. The emergency message may be triggered by a user or may be triggered by detection of an emergency condition. In some aspect, the wireless network may receive the message from the UE during the RACH procedure associated with the type of message scheduled, e.g., at 703, and one or more ROs or one or more preamble sequences associated with the RACH procedures dedicated for a type of the message as indicated by the system information received at 704. In one aspect, the wireless network may receive the message in the Msg3 or the MsgA in a PUSCH occasion for the RACH procedure associated with the type of the message. For example, 706 may be performed by a communications manage component 944.

At 708, the wireless network may be configured to forward the UE information based on the message received from the UE at 706. For example, 708 may be performed by a transmission component 934.

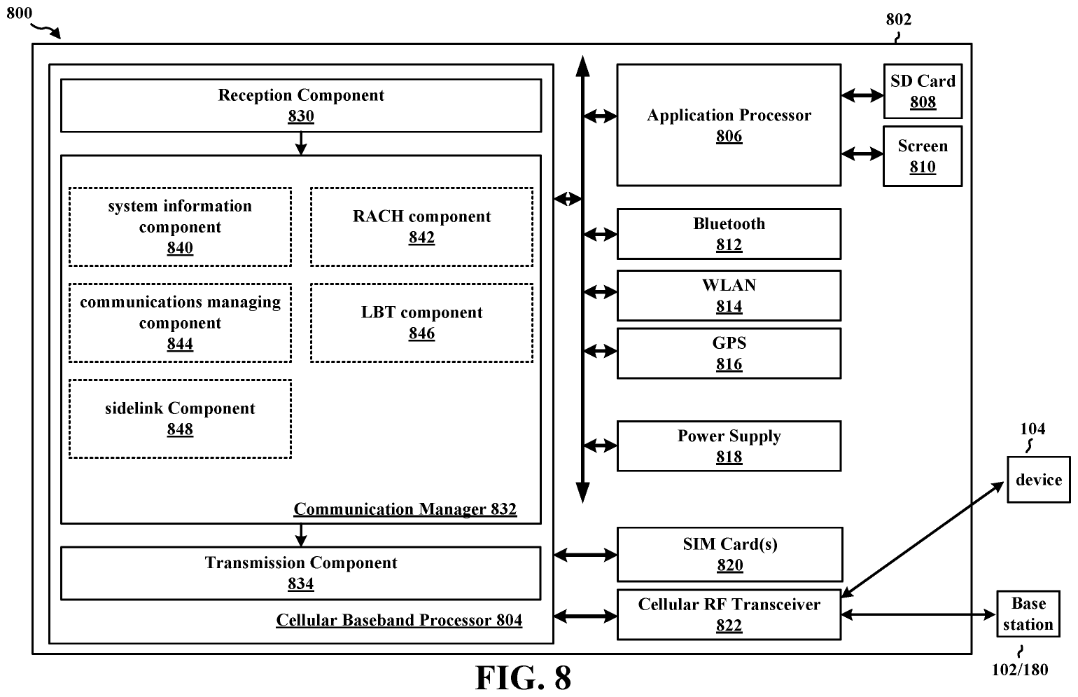

FIG. 8 is a diagram 800 illustrating an example of a hardware implementation for an apparatus 802. The apparatus 802 is a UE and includes a cellular baseband processor 804 (also referred to as a modem) coupled to a cellular RF transceiver 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the cellular RF transceiver 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 350 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see 350 of FIG. 3) and include the aforediscussed additional modules of the apparatus 802.

The communication manager 832 includes a system information component 840 that is configured to receive a MIB or an RMSI indicating that a synchronization raster includes system information or the time or frequency resources, and receive system information from the wireless network that indicates the time or frequency resources for transmitting the message, e.g., as described in connection with 602 and 604. The communication manager 832 includes a RACH component 842 that is configured to receive scheduling information for transmitting the message during a RACH procedure, determine that the UE fails to access a first type of wireless network to establish an RRC connection, and receive a RAR UL grant including the scheduling information for a Msg3, e.g., as described in connection with 603, 610, and 615. The communication manager 832 includes a communications manage component 844 that is configured to trigger the message in response to an occurrence of an emergency event and generate a message to be transmitted to the wireless network, e.g., as described in connection with 606 and 608. The communication manager 832 includes an LBT component 846 that is configured to perform an LBT procedure before transmitting the message to the wireless network, e.g., as described in connection with 612. The communication manager 832 includes a sidelink component 848 that is configured to coordinate the transmission of the message with one or more neighboring UEs, e.g., as described in connection with 614.

The apparatus may include additional components that perform each of the blocks of the algorithm in the aforementioned flowcharts of FIG. 6. As such, each block in the aforementioned flowcharts of FIG. 6 may be performed by a component, and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes means for generating a message including at least one of GPS coordinates, a timestamp, a UE ID, a personal ID of a user of the UE, an emergency level, or an emergency type; and means for transmitting the message to a wireless network, the UE being in one of an RRC idle mode or an RRC inactive mode. The apparatus 802 includes means for receiving system information from the wireless network that indicates the time or frequency resources and means for receiving a MIB or an RMSI indicating that a synchronization raster includes the system information or the time or frequency resources for transmitting the message. The apparatus 802 includes means for receiving scheduling information for transmitting the message during a RACH procedure associated with the type of message and means for receiving system information indicating the associated one or more ROs or one or more preambles that are configured for the type of the message. The apparatus 802 includes means for receiving a RAR UL grant, including the scheduling information for a Msg3, where the message is transmitted in the Msg3, and means for transmitting a MsgA in a PUSCH occasion for a RACH procedure associated with the type of the message. The aforementioned means may be one or more of the aforementioned components of the apparatus 802 configured to perform the functions recited by the aforementioned means. As described supra, apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

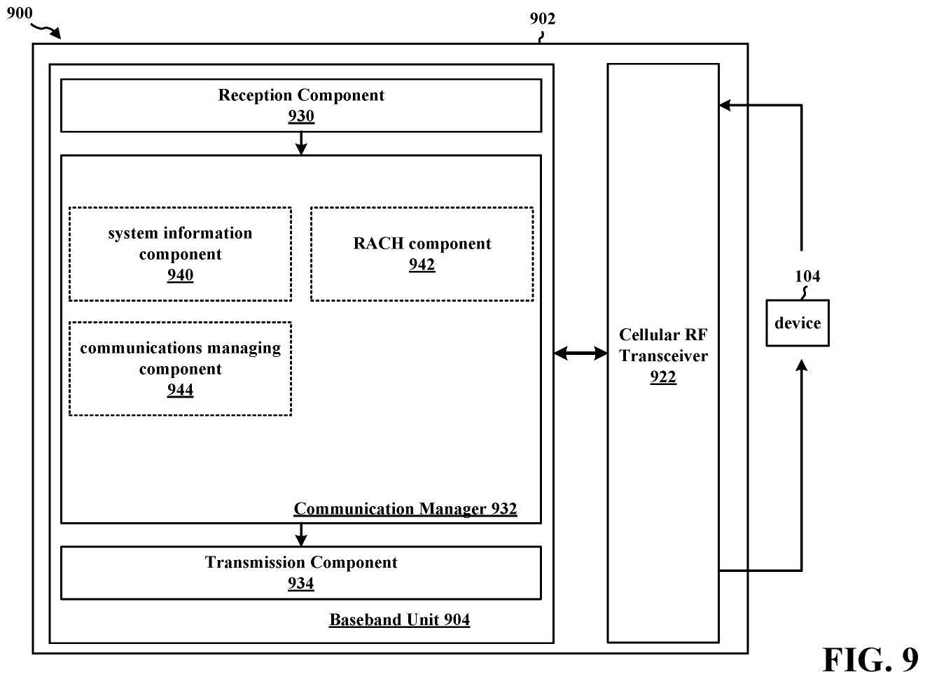

FIG. 9 is a diagram 900 illustrating an example of a hardware implementation for an apparatus 902. The apparatus 902 is a BS and includes a baseband unit 904. The baseband unit 904 may communicate through a cellular RF transceiver 922 with the UE 104. The baseband unit 904 may include a computer-readable medium/memory. The baseband unit 904 is responsible for general processing, including the execution of software stored on the computer-readable medium/memory. The software, when executed by the baseband unit 904, causes the baseband unit 904 to perform the various functions described supra. The computer-readable medium/memory may also be used for storing data that is manipulated by the baseband unit 904 when executing software. The baseband unit 904 further includes a reception component 930, a communication manager 932, and a transmission component 934. The communication manager 932 includes the one or more illustrated components. The components within the communication manager 932 may be stored in the computer-readable medium/memory and/or configured as hardware within the baseband unit 904. The baseband unit 904 may be a component of the BS 310 and may include the memory 376 and/or at least one of the TX processor 316, the RX processor 370, and the controller/processor 375.

The communication manager 932 includes a system information component 940 that is configured to transmit a MIB or an RMSI indicating that a synchronization raster includes system information or the time or frequency resources, and transmit system information to the UE that indicates the time or frequency resources for the UE to transmit the message, e.g., as described in connection with 702 and 704. The communication manager 932 further includes a RACH component 942 that is configured to transmit scheduling information for transmitting the message during a RACH procedure and transmit a RAR UL grant, including the scheduling information for a Msg3, e.g., as described in connection with 703 and 705. The communication manager 932 further includes a communications manage component 944 that is configured to receive the message from the UE, e.g., as described in connection with 706.

The apparatus may include additional components that perform each of the blocks of the algorithm in the aforementioned flowcharts of FIG. 7. As such, each block in the aforementioned flowcharts of FIG. 7 may be performed by a component, and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the baseband unit 904, includes means for receiving, from a UE in one of an RRC idle mode or an RRC inactive mode, a message including GPS coordinates, and means for forwarding UE information to a network based on the received message. The apparatus 902 includes means for transmitting system information from the wireless network that indicates the time or frequency resources and means for transmitting a MIB or an RMSI, indicating that a synchronization raster includes the time or frequency resources for the UE to transmit the message. The apparatus 902 includes means for transmitting scheduling information for transmitting the message during a RACH procedure associated with the type of message, means for transmitting system information indicating the associated one or more ROs or one or more preambles that are configured for the type of the message, means for transmitting a RAR UL grant including the scheduling information for a Msg3, where the message is received in the Msg3, and means for receiving a MsgA in a PUSCH occasion for a RACH procedure associated with the type of the message. The aforementioned means may be one or more of the aforementioned components of the apparatus 902 configured to perform the functions recited by the aforementioned means. As described supra, apparatus 902 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and is not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE, the method including generating a message including GPS coordinates and transmitting the message to a wireless network, the UE being in one of an RRC idle mode or an RRC inactive mode.

Aspect 2 is the method of aspect 1, where the message further includes a timestamp,

Aspect 3 is the method of any of aspects 1 and 2, where the message further includes a UE ID,

Aspect 4 is the method of any of aspects 1 to 3, where the message further includes a personal ID of a user of the UE,

Aspect 5 is the method of any of aspects 1 to 4, where the message further includes an emergency level,

Aspect 6 is the method of any of aspects 1 to 5, where the message further includes an emergency type,

Aspect 7 is the method of any of aspects 1 to 6, where the transmitting the message to the wireless network includes transmitting the message on a dedicated time or frequency resource that is dedicated for a type of the message.

Aspect 8 is the method of aspect 7, where the dedicated time or frequency resource is based on a global allocation.

Aspect 9 is the method of any of aspects 7 and 3 where the dedicated time or frequency resource is based on at least one of the GPS coordinates or satellite ephemeris information.

Aspect 10 is the method of any of aspects 7 and 4, where the message is transmitted in a frequency resource for messages without time domain synchronization with the wireless network.

Aspect 11 is the method of any of aspects 1 to 10, further including receiving system information from the wireless network that indicates time or frequency resources, where the UE transmits the message using a resource indicated in the system information.

Aspect 12 is the method of aspect 11, further including receiving a MIB or an RMSI indicating that a synchronization raster includes the system information or the time or frequency resources for transmitting the message.

Aspect 13 is the method of any of aspects 11 and 12, where the time or frequency resources indicated in the system information are consistent over time.

Aspect 14 is the method of aspect 8, where the system information indicates a duration of time associated with the time or frequency resources.

Aspect 15 is the method of any of aspects 11 to 14, where the system information includes a first synchronization raster indicating time frequency resources for transmitting the message, and a second synchronization raster indicating one or more frequency and/or time domain locations for the first synchronization raster.

Aspect 16 is the method of any of aspects 1 to 15, further including receiving scheduling information for transmitting the message during a RACH procedure associated with the type of message, where the UE transmits the message using the scheduling information.

Aspect 17 is the method of aspect 16, where one or more ROs or one or more preamble sequences associated with the RACH procedures are dedicated for a type of the message.

Aspect 18 is the method of aspect 17, further including receiving system information indicating the associated one or more ROs or one or more preambles that are configured for the type of the message.

Aspect 19 is the method of any of aspects 16 to 18, further including receiving a RAR UL grant including the scheduling information for a Msg3, where the message is transmitted in the Msg3.

Aspect 20 is the method of any of aspects 1 to 19, further including transmitting a MsgA in a PUSCH occasion for a RACH procedure associated with the type of the message.

Aspect 21 is the method of any of aspects 1 to 20, where the wireless network includes an NTN.

Aspect 22 is the method of any of aspects 1 to 21, where the message includes an NR-NTN message.

Aspect 23 is the method of aspect 22, where the message is transmitted in a time frequency resource dedicated for a type of the NTN message.

Aspect 24 is the method of aspect 23, where the type of the NTN message includes an emergency NTN message.

Aspect 25 is the method of aspect 24, further including triggering the emergency NTN message in response to an occurrence of an emergency event.

Aspect 26 is the method of any of aspects 1 to 25, further including determining that the UE fails to access a first type of wireless network to establish an RRC connection, where the UE transmits the message to a second type of wireless network based on the determination that the UE fails to access the first type of wireless network to establish the RRC connection.

Aspect 27 is the method of aspect 26, where the first type of wireless network is a terrestrial wireless network, and the second type of wireless network is an NTN.

Aspect 28 is the method of any of aspects 1 to 27, further including performing an LBT procedure before transmitting the message to the wireless network, where the UE transmits the message to the wireless network based on resources allocated for transmission of a type of the message being available for transmission.

Aspect 29 is the method of any of aspects 1 to 28, further including coordinating transmission of the message with one or more neighboring UEs.

Aspect 30 is the method of aspect 29, where coordinating the transmission includes exchanging sidelink communication with the one or more neighboring UEs.

Aspect 31 is the method of aspect 29 and 30, where the UE and the one or more UEs sequentially repeats the transmission of the message.

Aspect 32 is the method of aspect 29 and 30, where the UE and the one or more UEs transmit the message simultaneously to the wireless network

Aspect 33 is an apparatus for wireless communication including at least one processor coupled to a memory and configured to implement a method as in any of aspects 1 to 32.

Aspect 34 is an apparatus for wireless communication including means for implementing a method as in any of aspects 1 to 32.

Aspect 35 is a computer-readable medium storing computer executable code, where the code when executed by a processor causes the processor to implement a method as in any of aspects 1 to 32.

Aspect 36 is a method of wireless communication at a wireless network, the method including receiving, from a UE in one of an RRC idle mode or an RRC inactive mode, a message including GPS coordinates, and forwarding UE information to a network based on the received message.

Aspect 37 is a method of aspect 36, where the message further includes a timestamp.

Aspect 38 is a method of any of aspects 36 and 37, where the message further includes a UE ID.

Aspect 39 is a method of any of aspects 36 to 38, where the message further includes a personal ID of a user of the UE.

Aspect 40 is a method of any of aspects 36 to 39, where the message further includes an emergency level.

Aspect 41 is a method of any of aspects 36 to 40, where the message further includes an emergency type.

Aspect 42 is the method of any of aspects 36 to 41, where the receiving the message includes receiving the message on a dedicated time or frequency resource that is dedicated for a type of the message.

Aspect 43 is the method of aspect 42, where the dedicated time or frequency resource is based on a global allocation.

Aspect 44 is the method of any of aspects 42 and 43, where the dedicated time or frequency resource is based on at least one of the GPS coordinates or a satellite ephemeris information.

Aspect 45 is the method of any of aspects 42 to 44, further including where the message is received in a frequency resource for messages without time domain synchronization with the wireless network.

Aspect 46 is the method of any of aspects 36 to 45, further including transmitting system information from the wireless network that indicates time or frequency resources, where the wireless network receives the message using a resource indicated in the system information.

Aspect 47 is the method of aspect 46, further including transmitting a MIB or an RMSI indicating that a synchronization raster includes the time or frequency resources for the UE to transmit the message.

Aspect 48 is the method of aspects 46 and 47, where the time or frequency resources indicated in the system information are consistent over time.

Aspect 49 is the method of aspect 48, where the system information indicates a duration of time associated with the time or frequency resources.

Aspect 50 is the method of any of aspects 46 to 49, where the system information includes a first synchronization raster indicating time frequency resources for transmitting the message, and a second synchronization raster indicating one or more frequency and/or time domain locations for the first synchronization raster.

Aspect 51 is the method of any of aspects 36 to 50, further including transmitting scheduling information for transmitting the message during a RACH procedure associated with the type of message, where the wireless network receives the message using the scheduling information.

Aspect 52 is the method of aspect 51, where one or more ROs or one or more preamble sequences associated with the RACH procedures are dedicated for a type of the message.

Aspect 53 is the method of any of aspects 51 and 52, further including transmitting system information indicating the associated one or more ROs or one or more preambles that are configured for the type of the message.

Aspect 54 is the method of any of aspects 51 to 53, further including transmitting a RAR UL grant including the scheduling information for a Msg3, where the message is received in the Msg3.

Aspect 55 is the method of any of aspects 36 to 54, further including receiving a MsgA in a PUSCH occasion for a RACH procedure associated with the type of the message.

Aspect 56 is the method of any of aspects 36 to 55, where the wireless network includes a NTN.

Aspect 57 is the method of any of aspects 36 to 56, where the message includes a NR-NTN message.

Aspect 58 is the method of aspect 57, where the message is received in a time frequency resource dedicated for a type of the NTN message.

Aspect 59 is the method of aspect 58, where the type of the NTN message includes an emergency NTN message.

Aspect 60 is an apparatus for wireless communication including at least one processor coupled to a memory and configured to implement a method as in any of aspects 36 to 59.

Aspect 61 is an apparatus for wireless communication including means for implementing a method as in any of aspects 36 to 59.

Aspect 62 is a computer-readable medium storing computer executable code, where the code when executed by a processor causes the processor to implement a method as in any of aspects 36 to 59.

What is claimed is:

1. A method of wireless communication at a user equipment (UE), comprising:
generating a message comprising at least one of global positioning system (GPS) coordinates, a timestamp, a UE identifier (ID), a personal ID of a user of the UE, an emergency level, or an emergency type; and
transmitting the message to a wireless network, the UE being in one of a radio resource control (RRC) idle mode or an RRC inactive mode.

2. The method of claim 1, wherein the transmitting the message to the wireless network comprises transmitting the message on a dedicated time or frequency resource that is dedicated for a type of the message.

3. The method of claim 2, wherein the dedicated time or frequency resource is based on a global allocation.

4. The method of claim 2, wherein the dedicated time or frequency resource is based on at least one of the GPS coordinates or satellite ephemeris information.

5. The method of claim 2, wherein the message is transmitted in a frequency resource for messages without time domain synchronization with the wireless network.

6. The method of claim 1, further comprising:
receiving system information from the wireless network that indicates time or frequency resources, wherein the UE transmits the message using a resource indicated in the system information.

7. The method of claim 6, further comprising:
receiving a master information block (MIB) or a remaining minimum system information (RMSI) indicating that a synchronization raster comprises the system information or the time or frequency resources for transmitting the message.

8. The method of claim 6, wherein the time or frequency resources indicated in the system information are consistent over time.

9. The method of claim 8, wherein the system information indicates a duration of time associated with the time or frequency resources.

10. The method of claim 6, wherein the system information comprises:
a first synchronization raster indicating time frequency resources for transmitting the message; and
a second synchronization raster indicating one or more frequency and/or time domain locations for the first synchronization raster.

11. The method of claim 1, further comprising:
receiving scheduling information for transmitting the message during a random access channel (RACH) procedure associated with the type of message, wherein the UE transmits the message using the scheduling information.

12. The method of claim 11, wherein one or more RACH occasions (ROs) or one or more preamble sequences associated with the RACH procedures are dedicated for a type of the message.

13. The method of claim 12, further comprising:
receiving system information indicating the associated one or more ROs or one or more preambles that are configured for the type of the message.

14. The method of claim 11, further comprising:
receiving a random access response (RAR) uplink (UL) grant comprising the scheduling information for a message 3 (Msg3), wherein the message is transmitted in the Msg3.

15. The method of claim 1, further comprising:
transmitting a message A (MsgA) in a physical uplink shared channel (PUSCH) occasion for a random access channel (RACH) procedure associated with the type of the message.

16. The method of claim 1, wherein the wireless network comprises a non-terrestrial network (NTN).

17. The method of claim 1, wherein the message comprises a new radio (NR) non-terrestrial network (NTN) (NR-NTN) message.

18. The method of claim 17, wherein the message is transmitted in a time frequency resource dedicated for a type of the non-terrestrial network (NTN) message.

19. The method of claim 18, wherein the type of the NTN message comprises an emergency NTN message.

20. The method of claim 19, further comprising:
triggering the emergency NTN message in response to an occurrence of an emergency event.

21. The method of claim 1, further comprising:
determining that the UE fails to access a first type of wireless network to establish an RRC connection,
wherein the UE transmits the message to a second type of wireless network based on the determination that the UE fails to access the first type of wireless network to establish the RRC connection.

22. The method of claim 21, wherein the first type of wireless network is a terrestrial wireless network, and the second type of wireless network is a non-terrestrial network NTN).

23. The method of claim 1, further comprising:
performing a listen-before-talk (LBT) procedure before transmitting the message to the wireless network,
wherein the UE transmits the message to the wireless network based on resources allocated for transmission of a type of the message being available for transmission.

24. The method of claim 1, further comprising coordinating transmission of the message with one or more neighboring UEs.

25. The method of claim 24, wherein coordinating the transmission includes exchanging sidelink communication with the one or more neighboring UEs.

26. The method of claim 24, wherein the UE and the one or more UEs sequentially repeats the transmission of the message.

27. The method of claim 24, wherein the UE and the one or more UEs transmit the message simultaneously to the wireless network.

28. An apparatus for wireless communication, comprising:
a memory; and
at least one processor coupled to the memory and configured to:
generate a message comprising at least one of global positioning system (GPS) coordinates, a timestamp, a UE identifier (ID), a personal ID of a user of the UE, an emergency level, or an emergency type; and
transmit the message to a wireless network, the UE being in one of a radio resource control (RRC) idle mode or an RRC inactive mode.

29. A method of wireless communication at a wireless network, comprising:
receiving, from a user equipment (UE) in one of a radio resource control (RRC) idle mode or an RRC inactive mode, a message comprising at least one of global positioning system (GPS) coordinates, a timestamp, a UE identifier (ID), a personal ID of a user of the UE, an emergency level, or an emergency type; and
forwarding UE information to a network based on the received message.

30. An apparatus for wireless communication, comprising:
a memory; and
at least one processor coupled to the memory and configured to:
receive, from a user equipment (UE) in one of a radio resource control (RRC) idle mode or an RRC inactive mode, a message comprising at least one of global positioning system (GPS) coordinates, a timestamp, a UE identifier (ID), a personal ID of a user of the UE, an emergency level, or an emergency type; and
forward UE information to a network based on the received message.
